(19) United States
(12) Patent Application Publication
(10) Pub. No.: US 2004/0115528 A1
(43) Pub. Date: Jun. 17, 2004

(54) Electrochemical cells and their packaging

(76) Inventor: Karl Jorgen Helmich, Odense S (DK)

Correspondence Address: Paul Fields, Darby & Darby, P O Box 5257, New York, NY, 10150-5257, US

(21) Appl. No.: 10/416,983

(22) PCT Filed: Dec. 4, 2001
(86) PCT No.: PCT/IB01/02782

(30) Foreign Application Priority Data
Dec. 5, 2000 (GB) 0029625.1

(51) Int. Cl. H01M 2/08; H01M 10/04

(52) U.S. Cl. 429/181; 29/623.2; 429/185

(57) ABSTRACT

The application discloses a method of packaging an electrochemical cell wherein a cell precursor is arranged between one or more sheets of sealing material and sealed in the material such that connections (5) for the cell extend beyond the seal (4). The sealing material has slits or apertures (7) which, when the cell precursor is sealed in the material, are arranged to the outer side of the seal (4) at the cell connections and which register with the connections extending beyond the said seal. In the method, at least one cut (AB, CD, EF) is made between the slits or apertures (7) to remove excess sealing material from the cell connections.

The present invention concerns electrochemical cells, for example lithium-ion cells, and methods of packaging such cells.

In recent years there has been a great deal of interest in the development of electrochemical cells, especially lithium ion battery cells. Typically such cells have a prismatic or rectangular flat form and are covered by a flexible packaging material.

One very important requirement related to the packaging material is the complete air-tightness of the material and its sealed edges. Furthermore, corrosion- and dilution-resistance towards the electrolyte and the external environment of the packaging material are important.

The flexible packaging material is usually a laminate comprising a metal foil, an outer protection layer, and an inner heat sealable plastic layer. The metal foil typically is an aluminium foil which is diffusion tight. As an outer protection layer polyethylene is often used. The heat sealable plastic can be selected from the group comprising of polyethylene, polyester, polyamides, polypropylene and combinations thereof.

The laminate can also comprise a short-circuit protection layer between the heat sealable layer and the metal foil. This layer must be electrically insulating and has a higher melting point compared to the heat-sealable layer, thereby reducing the risk of the electrical connectors (cell tabs) coming into electrical contact with the metal foil.

Still further, the packaging material can comprise layers or additives which have a neutralising effect on acids from the electrolyte and/or layers which increase the adhesive strength between adjacent layers.

There are different types of sealing/packaging techniques which are used to enclose the cells in sealing material. In general a sealing pouch or bag with one open end is formed. The cell precursor (for a wound cell this is known as a “jelly roll”) is put into the bag, or the bag is formed around the precursor, and the tabs of the precursor protrude from the open end of the bag. Hereafter, the electrolyte may be added and the top end of the bag is sealed by heat sealing. The tabs which protrude from the top end of the bag can then be connected to external electrical circuits.

One main disadvantage of these methods is that the tabs are susceptible to damage or short circuits in the course of further handling. This can lead to deterioration of the tabs/cells and to a potentially dangerous situation in the production area. One special risk of short-circuit is due to the fact that the cut edge of the aluminium foil in the laminate can come into electrical contact with the tabs.

Other types of packaging techniques make use of a bag having a length which is able to cover the cell-precursor including the connecting tabs. The end-sealing is again made as close as possible to the cell precursor. In these techniques the tabs will be covered and protected by the protruding part of the sealing bag during the further handling of the cell. The advantage of these techniques is that short-circuits caused by the cut edge of the packaging foil are avoided and that the tabs are physically protected from bending or stress. However, it is necessary for later processing to have access to the tabs and so the protruding part of the sealing material either has to be bent or cut away from the tabs at a subsequent production stage, and these cutting or bending steps are themselves problematical.

One popular packaging method is the so-called flow packaging method. With this method the individual cell-precursors are placed in the longitudinal direction on the centre-line of a long (continuous) strip of packaging material. In a continuous production line the packaging material is folded around the individual cells. The basic principle of flow packing is illustrated in WO 97/38905, where it is used for food packaging. When packaging electrochemical cells, the packaging material usually comprises an inner heat-sealable layer and the longitudinal edges of the packaging material are sealed to each other on one side of the cell to form a so-called fin-seal. Similarly, the edges of the bottom end of the sealing material are sealed to each other. At the top end (tab-end) the packaging material is cut off from the packaging strip to a length which is long enough to cover the cell and tabs for their whole length.

Thereafter further process steps typically include electrolyte filling, vacuum sealing, initialisation, release of excess gasses and final sealing across the tabs. During the further processing the excess packaging material around the tabs has to be removed by cutting away or has to be folded away.

The main disadvantage of edge-sealed packing processes compared to flow-packing processes is that the sealing edges at the sides of the package contribute significantly to the width and volume of the cell.

The necessity to remove excess package material is present when using the above described flow-packing process, but also when using other packaging methods where tabs are covered by packaging material. The cutting away and/or folding must be done carefully to avoid damage to the tabs and/or short-circuits and this cutting step is difficult to automate.

Accordingly there exists a need for a method which ensures that the tabs are physically protected during the production phase following the packaging step while providing an easy uncovering of the tabs and removal of excess packaging material. At the same time, the tabs of the cell should preferably be electrically protected against potential short-circuiting caused by the cut-edge of the sealing material.

An attempt to solve some of the above problems is described in U.S. Pat. No. 5,948,562 to Motorola. US '562 proposes to keep the tabs enclosed within an interior portion of the packaging material to protect the tabs and to provide a part of the packaging material covering the tabs with small apertures through which electrical connection can be established. The disadvantage of this structure is that it provides only a limited access to the tabs, and that the extra packaging material around the tabs increases the weight and volume of the cell. In order to prevent tab short-circuiting, US '562 suggests the use of a piece of tape between the tabs and metal foil. The suggested tape is a heat-sealable material with similar melting temperature as the heat-sealable layer of the packaging material. Accordingly the tape will partly melt and thereby reduce in thickness and insulating performance.

U.S. Pat. No. 4,997,732, EP-A-390557 and U.S. Pat. No. 6,120,935 disclose electrochemical cell packages which have apertures exposing the electrodes for contact. Other cell package arrangements are shown in WO-A-97/08762 and EP-A-0942477.

One object of the invention is to provide a method and a packaging system which ensures an efficient sealing, reduced risk of tab damage and/or short-circuiting, and the possibility of a reliable and automatic production process.

One solution according to the invention is to provide the packaging material with slits or apertures which in use register with the tabs. The apertures are preferably substantially rectangular windows. There are preferably four such apertures or slits next to each other across the strip of packaging material, before folding around the cell precursor. Preferably the width of each aperture or slit is greater than that of each tab or tab-pair (one or more tabs can be provided for each of the negative and the positive electrical connections.)

At a minimum, one cut is made between the tabs and because the apertures/slits are wider than the tabs the cut does not need to be right up to the tabs.

The removal or cutting away of excess packaging material can now be done by a relatively easy cut. Preferably, a cutting tool consisting of three knives/cutting edges is used, these knives or cutting edges having a width corresponding to the width of the excess packaging material to each side of the tabs and to the width between the two tab arrangements respectively.

Compared to conventional arrangements where the packaging material has to be cut away from the tabs, the main advantage of the invention is that the cutting is done without having to cut close to the tabs, since the aperture edges or the slits function themselves as pre-cut lines. Thus the risk of damaging the tabs is minimised and the cutting process can more easily be implemented in an automated production line.

Compared to arrangements where the excess packaging material is sliced and folded back to uncover the tabs, the method according to the invention has the advantage that there are no excess flaps of packaging material which could accidentally come across under the (automated) initialisation process. A further advantage is that the cutting tool does not have to be designed according to the length of the tabs. The latter factor makes the production/cutting equipment more versatile and able to be used for different types/sizes of cells.

Furthermore, the method avoids any unintended melting of the sealing layer on that part of the packaging material which is to be removed from the tabs. Such melting makes the packaging material difficult to remove from the tabs.

In a preferred embodiment of the invention, a piece of insulating tape is placed between the tabs and the cut-edge of the packaging material in order to avoid tab short-circuiting caused by the edge of the metal foil coming into contact with the tabs. The length of the tape is greater than the width of the positive and negative tab arrangements, respectively. The tape has to be wide enough to provide an efficient short-circuit barrier and preferably is mounted along the full width at the edge of the apertures or slits of the packaging material.

The material and thickness of the tape is to be selected in order to provide an efficient short circuit barrier. Preferably the tape has at least one outer adhesive layer. The tape can be attached to the packaging material or to the tabs.

In a further preferred version, the tape is a laminated material with at least one heat-sealable outer layer. Thereby the tape can be heat-sealed against the packaging material and/or against the tab. The short-circuit-barrier layer will prevent the tab from getting into electrical contact with the metal foil of the packaging material.

In a another preferred embodiment of the invention, the tape, which can include both the short-circuit barrier and at least one heat-sealable layer, is extended to cover the tabs over the whole width of the sealing area of the top sealing of the cell package. The advantage of this embodiment is that the short circuit-barrier can be limited to the tab area. Therefore it is not necessary to provide the whole of the packaging material with a short-circuit barrier. This reduces the volume, weight and costs of each cell.

The invention also provides an alternative solution to the same problem set out above. In the alternative solution, instead of providing the packaging material with apertures/slits before packaging, the material is perforated along a transverse line. During the packaging process the cell-precursor is located so that the perforated line is placed across the tabs. The packaging process is similar to the above described flow-packing processes for electrochemical cells.

The tabs can then be uncovered in a simple process step by pulling or ripping the excess packaging material off along the line of perforations.

It is understood that the strength of the perforated line should be optimised, so that the package is strong enough not to break during the packaging process, but still is weak enough to ensure that the material will break along the perforations when exposed to a stress force at the removal stage.

In the embodiment using perforations the same insulating tape arrangements can be applied as for the earlier embodiment using holes or slits.

In addition to the packaging methods described above, the invention is also directed to the products of the methods, ie the packaged cells, optionally with insulating material extending beyond the edge of the cut or broken sealing material. The invention further concerns the precut or perforated sealing material, and still further the intermediate product which consists of the packaged cell before the excess sealing material is removed, the tabs of the packaged cell being protected by the excess material.

Preferred embodiments of the invention are described in more detail below, by example only, and with reference to the accompanying drawings wherein:

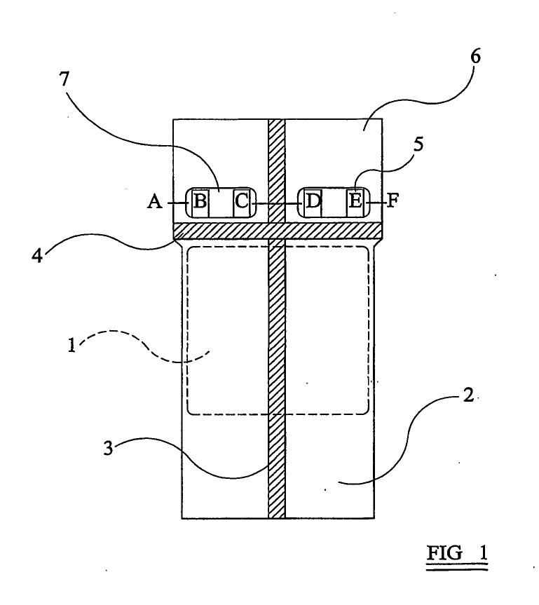

FIG. 1 is a plan view of an electrochemical cell package according to one embodiment of the invention;

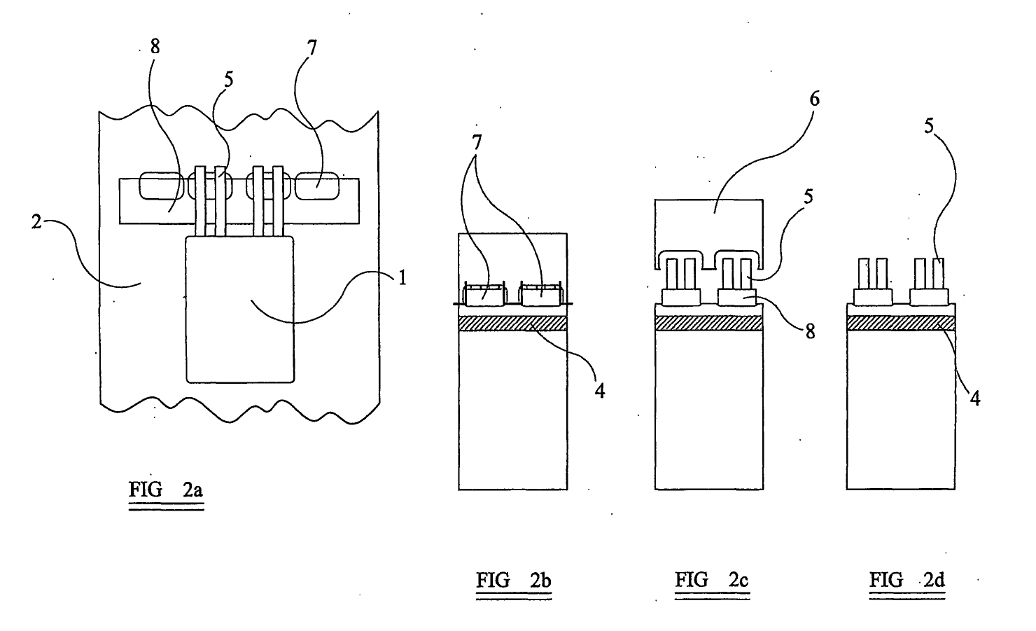

FIGS. 2a to 2d are schematic plan views showing the production steps for the cell package;

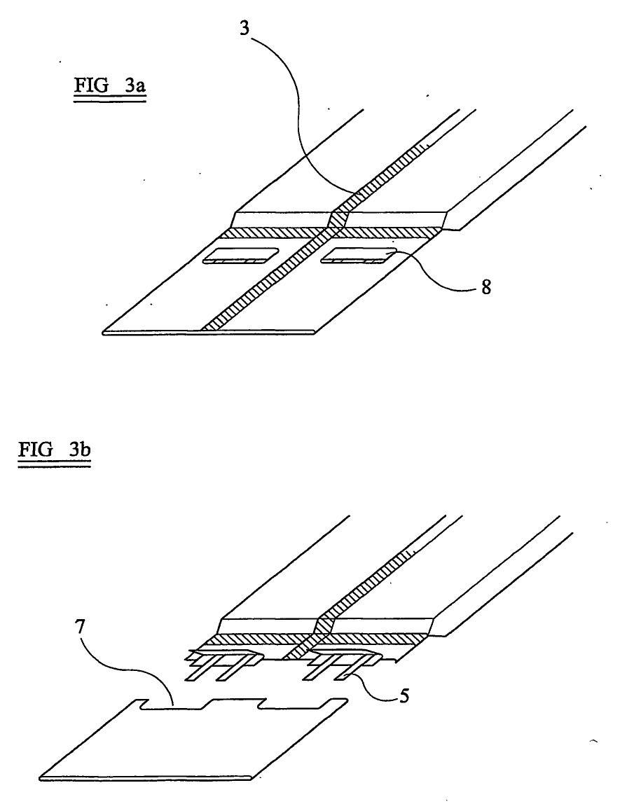

FIGS. 3a and 3b are perspective end views of the cell packages shown in FIGS. 2b and 2c;

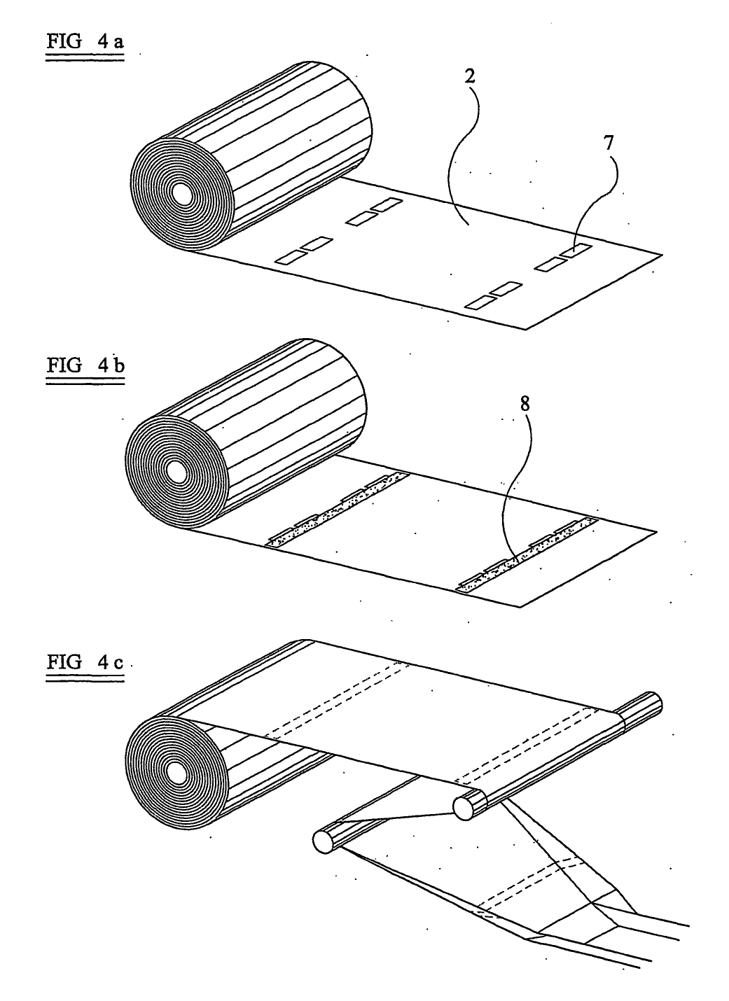

FIGS. 4a to 4c are further schematic views showing other aspects of the cell production process;

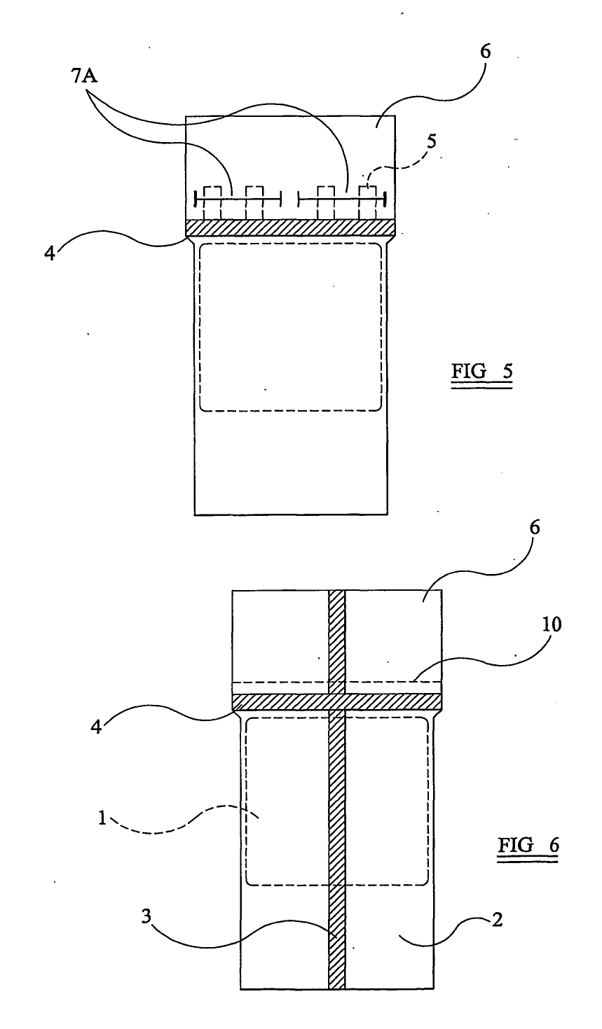

FIG. 5 is a plan view, similar to that of FIG. 1, but showing another embodiment of the invention;

FIG. 6 is a plan view, similar to that of FIG. 1, but showing another embodiment of the invention;

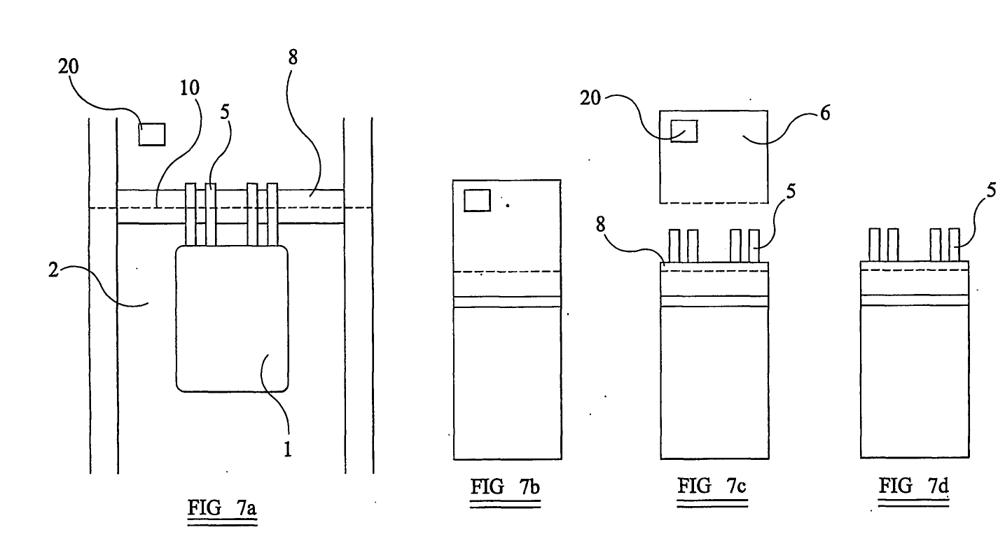

FIGS. 7a to 7d are schematic plan views showing the production steps for the cell package of FIG. 6;

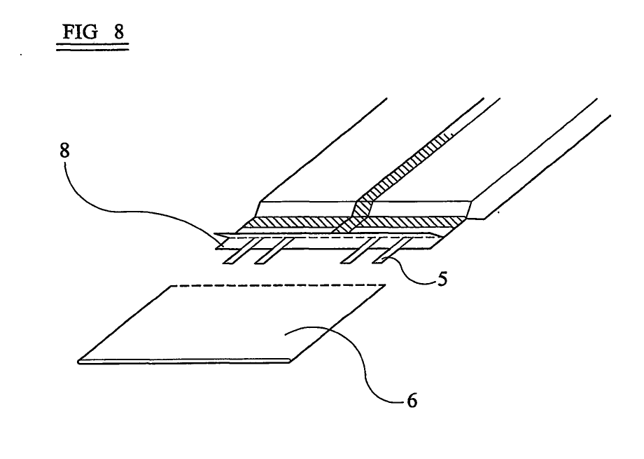

FIG. 8 is a perspective end view of the cell package of FIG. 7c; and

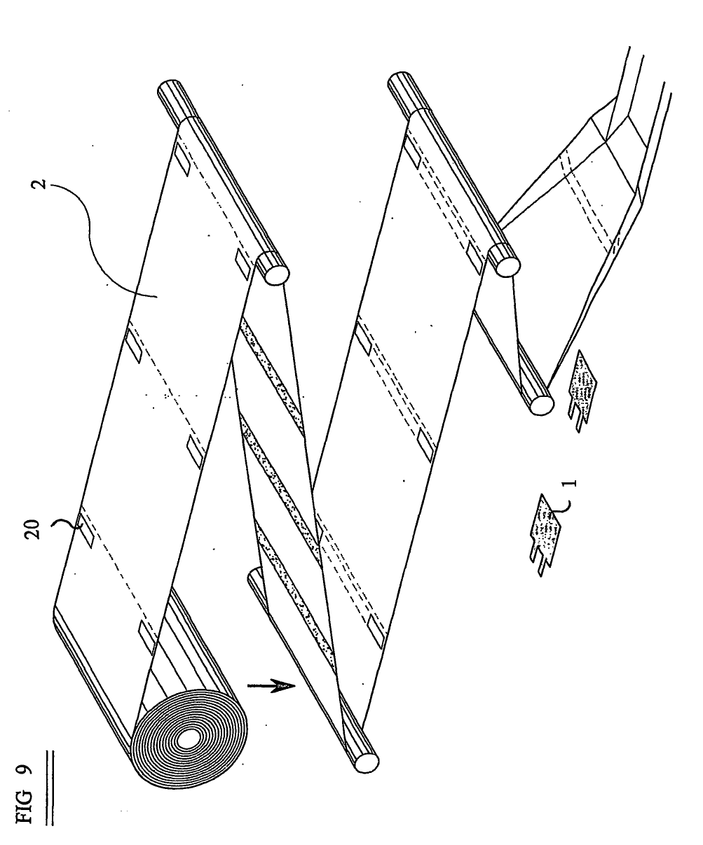

FIG. 9 is a schematic view showing another aspect of the production process for the cell package of FIG. 6.

As will have been apparent from the introduction to the patent application, the invention particularly concerns the packaging of a wound “jelly roll” cell which has either been wound to form a substantially flat, rectangular shape or has been wound on a circular winding mandrel, which is removed, the cell then being flattened. For convenience, in the following description, the word “longitudinal” is used to indicate a distance or direction of the cell which is parallel to the winding axis. The word “transverse” on the other hand is used to describe a direction which is perpendicular to the winding axis. Words such as “length” and “width” are used in an analagous fashion. In view of the fact that the tabs or terminals for electrical connection of the cells in practice extend in a direction parallel to the winding axis, the longitudinal direction will also accord with the orientation of the tabs.

In the plan view of FIG. 1 is shown a rectangular cell 1 sealed within a packaging material 2. The longitudinal “fin seal” 3 down the middle of one side of the cell package is shown, as is the transverse seal 4 which closes that end of the cell from which the tabs 5 protrude. In this cell, there is a pair of positive tabs and a pair of negative tabs, but this is not essential and in the following description “tab” or “tab arrangement” is intended to describe the positive tab or negative tab connection respectively, irrespective of how many individual tabs the connection is made up of.

The tabs are partly protected from damage and accidental folding by the fact that an extra length 6 of the sealing material of the package extends beyond the tab seal 4. However, the tabs are at least partly exposed through apertures or windows 7 formed in the sealing material, the windows in this embodiment being in the shape of rounded rectangles. The particular advantage of these windows is that the excess sealing material can be easily cut away without any risk of the cutting blades contacting the tabs. It will be understood that only three cuts are required, from point A to point B, from point C to point D, and from point E to point F. Because the windows extend beyond the edge of each tab arrangement, ie. to the sides of the tabs, there is a margin into which the blade can extend for reliable cutting of the material without touching the tabs. Because there is this margin, the cutting operation may be effected in an automatic process. The three cuts are made simultaneously by three blades on the same cutting unit, in a known manner. The central cut severs the fin seal 3 of the cell package, as well as the packaging material to either side.

It will be understood that there is also a margin in the longitudinal direction in which the cuts can be made, given that the windows have a longitudinal dimension as well as a transverse width.

In FIG. 1, the tabs 5 are illustrated as extending almost but not quite the full longitudinal dimension of the windows 7. However, this is not essential and the tabs could be shorter or indeed could be longer and thus extend further between the excess sealing material 6.

FIGS. 2a to 2d show schematically how the cell package may be formed if the cell is sealed within the sealing material using the flow packaging method described above. It will be obvious from this description how an analogous process would work with a method in which the cells were placed in a sealing pouch or bag with one open end, namely that the folding of the material is done before the cell precursor is inserted.

FIG. 2a shows that across the width of the sealing material 2, which width must of course wrap around both sides of the flat cell 1, are formed four apertures or windows 7. The outer aperture on each side is positioned so that after folding of the sealing material onto the cell it will register as closely as possible with the aperture which is on its inward side before folding. In this embodiment, the tabs 5 are shown extending across the full longitudinal dimension of the windows.

In this particular embodiment, an insulating tape 8 is placed across the width of the sealing material, this tape overlapping the lower edge of the windows 7 (that edge which is closer to the cell). This tape 8 is preferably adhered to the sealing material 2, though in a different version it could be sealed to the tabs. If the tape 8 is adhered to the sealing material across the full width then it is important that the tape does not reach the upper edge of the windows 7. If it did reach this edge, there would be a risk that after the cutting operation (see below) the extra part of the sealing material 6 could not so easily be removed as it would be adhered to the insulating tape 8 along those upper edges of the window.

FIG. 2b shows in bold lines the three cuts which are made to remove the excess sealing material. The cuts have a transverse dimension, so that they extend across the width of the sealing material and into the window areas, as well as a longitudinal dimension so that they cut across the insulating tape. The edge cuts are thus “L” shaped, whereas the central cut is a rectangular “U” shape. However, it is emphasized that as in FIG. 1 only three cutting steps are necessary and these steps will generally be effected simultaneously.

After the three cuts are made it will be understood that the excess sealing material 6 is separated from the cell package and can thus be removed, as indicated in FIGS. 2c and 2d. The hatched strip shown by reference numeral 4 in FIGS. 2b to 2d represents the transverse seal at the tab end of the cell, to seal the cell within the packaging material. FIGS. 2c and 2d show that substantially all of those portions of the insulating tape 8 which were visible within the windows 7 as seen in FIG. 2b remain over the tabs, while the parts of the tape 8 to the sides of the tabs 5 are removed.

As will be apparent from the discussion in the introduction to this application, the main advantage of the insulating tape is that it provides a short circuit barrier between the edges of the sealing material, in particular along the lower edges of the windows. Without the insulating tape there would be some risk of short circuits occurring, after the subsequent step of initialization. Accordingly, the embodiment of FIG. 2 does have some advantages beyond the embodiment of FIG. 1.

FIGS. 3a and 3b are perspective views showing the cell package at the processing step schematically shown in FIGS. 2b and 2c. FIG. 3b shows that the portions of the insulating tape 8 in front of and behind the tabs 5 can be moved apart.

FIGS. 4a to 4c schematically indicate how the cells can be sealed in an automated procedure, though these figures do not indicate the later sealing and cutting steps. The sealing material 2 is unrolled and four windows 7 are punched at intervals across its width (FIG. 4a). The strip or tape of insulating material 8 is then adhered to the sealing material, overlapping with the windows (FIG. 4b) (individual sections of tape could instead be adhered). Then the cell is sealed within the material in a known fashion, in the flow packaging process (FIG. 4c).

In a preferred embodiment, the insulating tape extends sufficiently towards the cell that it is extended into the heat sealing area of transverse seal 4. With this method, the tape would make redundant the usual short circuit barrier which is present in conventional packaging materials. Accordingly, the costs of the packaging material can be significantly reduced and a simpler form of sealing material can be used.

Preferably, the insulating tape or pieces of tape (“labels”) consists of a 40 μm polyester strip with an acrylic adhesive layer. The tape can however also be based on polypropylene, polyethylene or paper in various thicknesses. Other materials for the tape as mentioned in U.S. Pat. No. 5,948,562 can also be used. The adhesive layer could also be based on rubber substances. In order to create a non-adhesive region on a part of the tape an UV lacquer (Ultra Violet curing lacquer) can be printed on this part of the tape. After curing, the adhesive material will not stick to the lacquered area.

One advantageous possibility is to use a three layered tape-laminate. The outer layers can be of a heat sealable material such as 50 μm EMAA (Ethylene Metha Acrylic Acid) of EAA (Ethylene Acrylic Acid). The inner layer can be of an electrical insulating material and should have a higher melting point compared to the outer layers. This inner layer can be a 12 μm thick polyester, for example.

The multilayered tape should at least cover the tabs on both sides in the top sealing area of the cell. Thereby the short-circuit barrier of the packaging material itself can be avoided.

Another version of what is shown in FIG. 1 will now be described with reference to FIG. 5. Instead of windows being formed in the sealing material there are instead “I” shaped cuts or slits 7A formed transversely. The body of each I-shaped cut is longer than the tab arrangement so that the head and foot of the I-shape cuts are arranged either side of the tabs, parallel to and at a certain distance from those tabs. With cuts AB, CD and EF as described in relation to FIG. 1, the excess sealing material is thus easily removed. In an even simpler embodiment, the initial cuts in the sealing material could be linear cuts or slits, but this would require a more exact positioning of the straight cutting knives which remove the excess material since there would be no positioning tolerance in a longitudinal direction. A cutting tolerance could be introduced by the knives having a longitudinal extent, as well as the transverse extent (e.g. the knives could be “T” shaped or “L” shaped).

It can be mentioned here that an advantage of the embodiment where windows or apertures are formed in the packaging material is that these windows can be used as a “sensor mark” for controlling the process steps, including application of the insulating tape and the cutting steps. In particular, a light switch for controlling the manufacturing steps can be triggered by the presence of the window.

In relation to the window embodiment, in one possible variation the pair of windows to either side of the sealing material (as seen for example in FIG. 2a) could be formed as one wide window which is folded around onto itself, in the packaging process, so that the window is half its initial size and extends to the edge of the cell package. In this less preferred embodiment, the sealing material (and insulating tape) would be called upon to provide rigidity to the cell package, because the excess sealing material is joined to the cell package only along a central strip, though it will be realized that only a single cut would be needed to remove the excess sealing material.

In the embodiment of FIG. 6, a different but related approach to the removal of the excess sealing material 6 is adopted. Instead of windows being formed in the sealing material, a line 10 of small slits or perforations is formed across the width of the material 2. In this method, full protection to the tabs 5 is provided after sealing by the sealing material as the tabs are not exposed through windows. Because of the line of weakness formed by the perforations, it is nonetheless a relatively easy step to pull off the excess material 6 to reveal the tabs 5. This process is schematically illustrated in FIGS. 7a to 7d and FIG. 8. It will be appreciated that in this embodiment also an insulating tape 8 may be present across the width of the sealing material.

The strip of insulating material 8 which is arranged across the packaging material should cover the line 10 of perforations. Furthermore, the insulating tape should only be adhered to the sealing material on the cell side. Thus after the excess material 6 is pulled off, the insulating tape 8 will overlap with and extend beyond the broken edge of the sealing material 2. The tape 8 can be preformed with longitudinal cuts either side of the tabs 5, if in later processing steps it is desirable that the tape can be folded back for increased access to the tabs 5 (this feature applies to all embodiments, see for example FIG. 3b and FIG. 8).

In another approach to the fixing of the insulating tape, the tape 8 can be adhered only along its top and bottom edges. The tape is thus preformed with an adhesive layer on these edges and in between the adhesive areas there is preformed a perforated line. During the manufacturing process, the adhesive tape is fixed to the sealing material so that the perforated line of the tape is offset relative to the perforated line 10 of the sealing material in such a way that after the cell is wrapped in the sealing material and after the excess material 6 is removed, the tape extends beyond the broken edge of the sealing material 2. The protruding part of the insulating tape is not adhered to the tabs, which is advantageous with regard to the later access to the tabs for connection etc.

It can be noted that this type of insulating tape, formed with adhesive edges and a perforation line could be used in connection with the embodiment where there are windows or apertures. In this case, all of the area of windows or apertures could be covered by the insulating tape and simple linear cuts between the windows would be sufficient to remove the excess sealing material (because the insulating tape would break along its perforated line and would not need cutting).

It should be emphasized that although for easy manufacturing it will generally be easiest to use a strip of insulating tape across the fill width of the sealing material, instead a number of small pieces of insulating tape could be used.

With regard to FIG. 9, which is similar to FIG. 4 in showing the flow packaging process for encapsulating the cells 1, it should be explained that the upper surface of the sealing material 2 has arranged along its edges sensor marks 20 for triggering optical sensors which control the insulating tape fixing step and the subsequent folding and cutting steps. The insulating tape can be seen on the other surface of the sealing material, as it passes from the top right hand roller to the bottom left hand roller. The dashed lines visible on the sealing material before the folding step show the positioning of the insulating tape, the middle dashed line indicating the perforations (line of weakness) of the sealing material.

1. A method of packaging an electrochemical cell wherein a cell precursor is arranged between one or more sheets of sealing material and sealed in the material such that the connections for the cell extend beyond the seal between excess sealing material, characterized in that the sealing material has slits or apertures which, when the cell precursor is sealed in the material, are arranged to the outer side of the seal at the cell connections and which register with the connections extending beyond the said seal, and in that at least one cut is made between the slits or apertures to remove at least some of said excess sealing material from the cell connections.

2. A method according to claim 1, wherein there are four apertures, pairs of which register when the sealing material is on both sides of the cell precursor.

3. A method according to claim 1 or 2, wherein the slits or apertures are wider than the cell connections with which they register.

4. A method according to any preceding claim, wherein insulating material is arranged on the inside of the sealing material so that it overlaps with the cut edge of the sealing material.

5. A method according to claim 4, wherein the insulating material is provided only in the connection sealing area of the cell, not the full area of the sealing material.

6. A method of packaging an electrochemical cell wherein a cell precursor is arranged between one or more sheets of sealing material and sealed in the material such that the connections for the cell extend beyond the seal between excess sealing material, characterized in that the sealing material has a line of weakness which, when the cell precursor is sealed in the sealing material, is arranged to the outer side of the seal across the cell connections, and in that at least some of the excess sealing material is pulled from the end of the sealed cell by breaking said material along the line of weakness.

7. A method according to claim 6, wherein the line of weakness is formed by a row of perforations.

8. A method according to claim 6 or 7, wherein insulating material is arranged at the seal of the cell connections, overlapping with the line of weakness.

9. A method according to claim 4 or 8, wherein the insulating material is formed with an adhesive layer thereon.

10. A method according to claim 9, wherein the adhesive is provided only along the edges of the insulating material.

11. A method according to claim 4, 8, 9 or 10, wherein the insulating material has a line of weakness, in particular a row of perforations, formed along a mid-portion thereof.

12. An electrochemical cell package comprising a cell precursor sealed between sheets of sealing material with a seal across the cell connections such that the connections and some sealing material extend beyond the seal, characterized in that slits, apertures or a line of weakness are arranged across the sealing material which covers the cell connections to the outer side of the seal.

13. An electrochemical cell according to claim 12, wherein there are two pairs of registering apertures.

14. An electrochemical cell package according to claim 12 or 13, wherein insulating material is provided on the inside of the sealing material, along the slits, apertures or line of weakness.

15. An electrochemical cell according to claim 12 or 14, wherein the line of weakness is formed by a row of perforations.

16. An electrochemical cell according to claim 14, wherein the insulating material is formed with an adhesive layer thereon.

17. An electrochemical cell according to claim 16, wherein the adhesive is provided only along the edges of the insulating material.

18. An electrochemical cell according to any of claims 4 to 17, wherein the insulating material has a line of weakness, in particular a row of perforations, formed along a mid-portion thereof.

19. A longitudinal strip of sealing material for sealing electrochemical cells wherein at intervals along its length, slits, apertures or a line of-weakness are formed transversely across the material.

20. A sealing material according to claim 19, wherein there are four apertures formed transversely at intervals along the length.

21. A sealing material according to claim 19, wherein each line of weakness is formed by a row of perforations.

22. A sealing material according to any of claims 19 to 21, wherein insulating material is provided on the inside of the sealing material, along the slits, apertures or line of weakness.

23. A sealing material according to claim 22, wherein the insulating material is formed with an adhesive layer thereon.

24. A sealing material according to claim 23, wherein the adhesive is provided only along the edges of the insulating material.

25. A sealing material according to any of claims 22 to 25, wherein the insulating material has a line of weakness, in particular a row of perforations, formed along a mid-portion thereof.
